(19) United States
(12) Patent Application Publication
(10) Pub. No.: US 2021/0048714 A1
(43) Pub. Date: Feb. 18, 2021

(54) DISPLAY DEVICE

(71) Applicant: Samsung Display Co., LTD., Yongin-si (KR)

(72) Inventor: KyoungDuck KIM, Hwaseong-si (KR)

(73) Assignee: Samsung Display Co., LTD., Yongin-si, Gyeonggi-do (KR)

(21) Appl. No.: 16/906,564

(22) Filed: Jun. 19, 2020

(30) Foreign Application Priority Data
Aug. 14, 2019 (KR) 10-2019-0099537

(51) Int. Cl. G02F 1/13357

(52) U.S. Cl. CPC G02F 1/133608

(57) ABSTRACT

A display device includes a display panel, light source substrates disposed under the display panel, light sources disposed on the light source substrates, and a first fixing part disposed between the light source substrates. The first fixing part includes a first main portion disposed between the light source substrates and first wings extending from an upper end of the first main portion to be substantially parallel to the light source substrates and disposed on the light source substrates.

### CROSS-REFERENCE TO RELATED APPLICATION

This application claims priority to and benefits of Korean Patent Application No. 10-2019-0099537 under 35 U.S.C. § 119, filed in the Korean Intellectual Property Office on Aug. 14, 2019, the entire contents of which are incorporated herein by reference.

### BACKGROUND

### 1. Technical Field

The disclosure relates to a display device capable of preventing light source substrates from being damaged.

### 2. Description of the Related Art

Among display devices, a display device including a non-light emitting display panel, such as a liquid crystal display panel, may further include a backlight to provide light to the display panel. The backlight may generate the light and provide the light to the display panel, and the display panel may display an image using light provided from the backlight.

As the backlight, an edge-illumination type backlight and a direct-illumination type backlight may be used. The direct-illumination type backlight may be disposed under the display panel and may provide light to the display panel. The direct-illumination type backlight may include an optical part and a light source part disposed under the optical part.

The light source part may include light source substrates, and light sources may be mounted on each of the light source substrates. The light source part may provide light to the optical part while being fixed to a bottom chassis.

It is to be understood that this background of the technology section is, in part, intended to provide useful background for understanding the technology. However, this background of the technology section may also include ideas, concepts, or recognitions that were not part of what was known or appreciated by those skilled in the pertinent art prior to a corresponding effective filing date of the subject matter disclosed herein.

### SUMMARY

The disclosure provides a display device capable of both stably fixing light source substrates to a bottom chassis and easily separating the light source substrates from the bottom chassis without damaging the light source substrates.

Embodiments may provide a display device that may include a display panel, light source substrates disposed under the display panel, light sources disposed on the light source substrates, and a first fixing part disposed between the light source substrates. The first fixing part may include a first main portion disposed between the light source substrates and first wings extending from an upper end of the first main portion to be substantially parallel to the light source substrates and disposed on the light source substrates.

The display device may further include an optical part between the display panel and the light source substrates. The light source substrates may be disposed in a first direction and a second direction crossing the first direction. The first fixing part may be disposed between a k-th light source substrate and a (k+1)th light source substrate among the light source substrates disposed in the first direction. The first wings may include a first sub-wing extending in the first direction and disposed on the k-th light source substrate, and a second sub-wing extending in the first direction and disposed on the (k+1)th light source substrate.

The display device may further include a bottom chassis that accommodates the light source substrates, the light sources, and the optical part. The first main portion may include a first body vertically extending between the light source substrates, and a supporter extending from a lower end of the first body to be substantially parallel to a bottom portion of the bottom chassis. The supporter may be disposed in a recess defined in the bottom portion of the bottom chassis.

The first fixing part may further include a fixing pin that fixes the light source substrates to the bottom chassis. The fixing pin may include a horizontal portion extending in the second direction, and a column portion extending downward from the horizontal portion. The horizontal portion may be disposed on the first wings, the column portion may be inserted into a first hole defined in the first main portion, and a lower end of the column portion may be connected to the bottom chassis. The column portion may be inserted into a second hole defined in a bottom portion of the bottom chassis to overlap the first hole. The lower end of the column portion may have a hook shape and may be disposed under the bottom chassis.

The display device may further include a second fixing part disposed at an edge of the bottom chassis. The second fixing part may include a second main portion disposed between the edge of a bottom portion of the bottom chassis and a corresponding light source substrate among the light source substrates, and a second wing extending from an upper end of the second main portion to be substantially parallel to the corresponding light source substrate and disposed on the corresponding light source substrate. The first fixing part may be disposed between a k-th light source substrate and a (k+1)th light source substrate among the light source substrates disposed in the second direction. The light source substrates may include a glass material. The first wings may be elastically deformable. The first wings may make contact with an upper portion of the light source substrates to fix the light source substrates.

Embodiments may provide a display device that may include a display panel, light source substrates disposed under the display panel, light sources disposed on the light source substrates, an optical part disposed between the display panel and the light source substrates, and a fixing part disposed between the light source substrates. The fixing part may include a main portion disposed between a K-th light source substrate and a (K+1)th light source substrate, a first wing extending from an upper end of the main portion to be substantially parallel to the K-th light source substrate, a second wing extending from the upper end of the main portion to be substantially parallel to the (K+1)th light source substrate, and a fixing pin disposed in a groove defined by the first wing and the second wing. The first wing and the second wing may be elastically deformable.

The display device may further include a bottom chassis that accommodates the light source substrates, the light sources, and the optical part. The fixing pin may include a column portion inserted into a first hole defined in the main portion and a second hole defined in a bottom portion of the bottom chassis, and a lower end of the column portion may be connected to the bottom chassis.

Embodiments may provide a display device that may include a display panel, light source substrates disposed under the display panel, light sources disposed on the light source substrates, an optical part disposed between the display panel and the light source substrates, and fixing parts disposed in one side of a corresponding light source substrate among the light source substrates. Each of the fixing parts may include a main portion disposed in the one side of the corresponding light source substrate and a wing extending from an upper end of the main portion to be substantially parallel to the corresponding light source substrate and disposed on the corresponding light source substrate. The wing may be elastically deformable.

The display device may further include a bottom chassis that accommodates the light source substrates, the light sources, and the optical part. Each of the fixing parts may include a fixing pin to fix the light source substrates to the bottom chassis. The fixing pin may include a column portion inserted into a first hole defined in the main portion and a second hole defined in a bottom portion of the bottom chassis.

According to the above, light source substrates may be easily fixed to or separated from a bottom chassis by wings that may have low rigidity and may be elastically deformable, and thus the light source substrates may be prevented from being damaged.

### BRIEF DESCRIPTION OF THE DRAWINGS

The above and other advantages of the disclosure will become readily apparent by reference to the following detailed description when considered in conjunction with the accompanying drawings wherein:

FIG. 1 is an exploded schematic perspective view showing a display device according to a first embodiment of the disclosure;

FIG. 2 is a view schematically showing a pixel of a display panel shown in FIG. 1;

FIG. 3 is a schematic cross-sectional view taken along line I-I′ shown in FIG. 1;

FIG. 4 is a schematic perspective view showing a configuration of one fixing part shown in FIG. 1;

FIG. 5 is a schematic perspective view showing light source substrates fixed to a bottom chassis by the fixing part shown in FIG. 4;

FIG. 6 is a schematic cross-sectional view taken along line II-IF shown in FIG. 5;

FIG. 7 is a schematic cross-sectional view taken along line shown in FIG. 5;

FIGS. 8 and 9 are schematic plan views showing the fixing parts disposed between the light source substrates in the display device according to the first embodiment of the disclosure;

FIG. 10 is a schematic perspective view showing a configuration of a fixing part of a display device according to a second embodiment of the disclosure;

FIG. 11 is a schematic perspective view showing light source substrates fixed to a bottom chassis by the fixing part shown in FIG. 10;

FIG. 12 is a schematic cross-sectional view taken along line IV-IV′ shown in FIG. 11;

FIG. 13 is a schematic cross-sectional view taken along line V-V′ shown in FIG. 11;

FIG. 14 is a schematic plan view showing the fixing parts disposed between the light source substrates in the display device according to the second embodiment of the disclosure;

FIG. 15 is a schematic plan view showing fixing parts disposed between light source substrates in a display device according to a third embodiment of the disclosure;

FIG. 16 is a schematic perspective view showing a configuration of a fixing part of a display device according to a fourth embodiment of the disclosure;

FIG. 17 is a schematic perspective view showing light source substrates fixed to a bottom chassis by the fixing part shown in FIG. 16;

FIG. 18 is a schematic cross-sectional view taken along line VI-VI′ shown in FIG. 17;

FIG. 19 is a schematic cross-sectional view taken along line VII-VII′ shown in FIG. 17; and

FIG. 20 is a schematic plan view showing the fixing parts disposed between the light source substrates in the display device according to the fourth embodiment of the disclosure.

### DETAILED DESCRIPTION OF THE EMBODIMENTS

In the disclosure, it will be understood that when an element or layer is referred to as being “on”, “connected to”, “coupled to”, or the like with respect to another element or layer, it can be directly on, connected or coupled to the other element or layer or intervening elements or layers may be present.

Like numerals refer to like elements throughout. In the drawings, the thickness, ratio, and dimension of components may be exaggerated for effective description of the technical content.

As used herein, the term “and/or” includes any and all combinations of one or more of the associated listed items. The terms “and” and “or” may be used in the conjunctive or disjunctive sense and may be understood to be equivalent to “and/or.”

It will be understood that, although the terms first, second, etc. may be used herein to describe various elements, components, regions, layers and/or sections, these elements, components, regions, layers and/or sections are not limited by these terms. These terms are only used to distinguish one element, component, region, layer or section from another region, layer or section. Thus, a first element, component, region, layer or section discussed below could be termed a second element, component, region, layer or section without departing from the teachings of the disclosure. As used herein, the singular forms, “a”, “an” and “the” are intended to include the plural forms as well, unless the context clearly indicates otherwise.

Spatially relative terms, such as “beneath”, “below”, “lower”, “bottom”, “above”, “upper”, “top” and the like, may be used herein for ease of description to describe one element or feature's relationship to another element(s) or feature(s) as illustrated in the figures.

The terms “overlap” or “overlapped” mean that a first object may be above or below or to a side of a second object, and vice versa. Additionally, the term “overlap” may include layer, stack, face or facing, extending over, covering or partly covering or any other suitable term as would be appreciated and understood by those of ordinary skill in the art. The terms “face” and “facing” mean that a first element may directly or indirectly oppose a second element.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “comprises”, “comprising”, “has”, “having”, “includes” and/or “including” specify the presence of stated features, integers, steps, operations, elements, and/or components, but do not preclude the presence or addition of one or more other features, integers, steps, operations, elements, components, and/or groups thereof.

Hereinafter, the disclosure will be explained in detail with reference to the accompanying drawings.

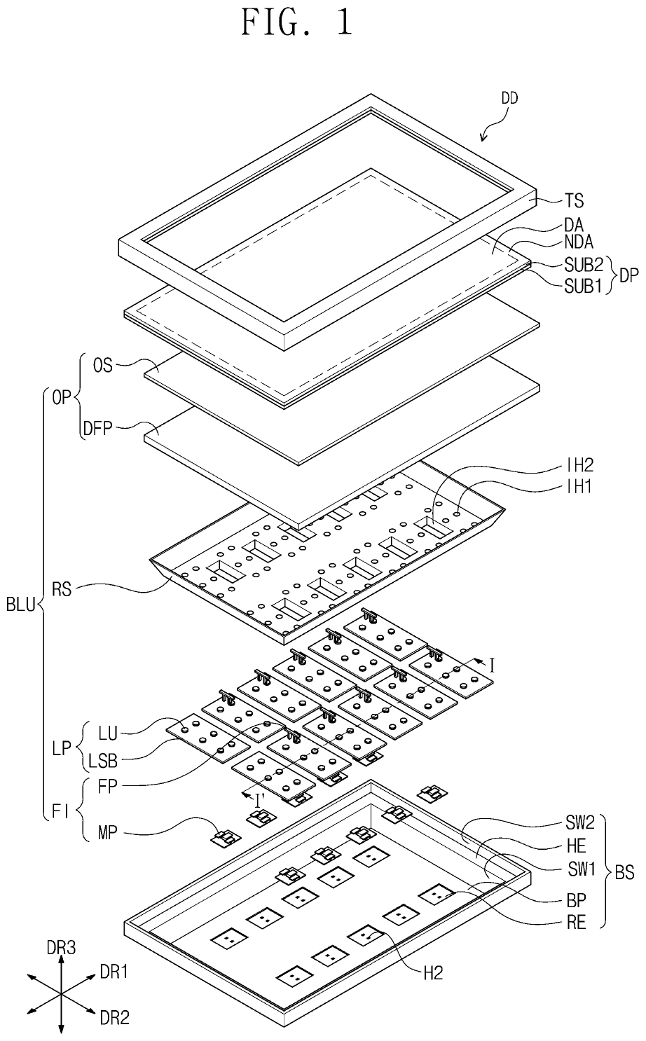

FIG. 1 is an exploded schematic perspective view showing a display device DD according to a first embodiment of the disclosure.

Referring to FIG. 1, the display device DD according to the first embodiment of the disclosure may include a display panel DP, a backlight member BLU, a bottom chassis BS, and a top chassis TS. As the display panel DP, a variety of display panel technologies that may display an image, such as a liquid crystal display panel, an electrophoretic display panel, or an electrowetting display panel, may be used. As a representative example, the display panel DP may be a liquid crystal display panel.

The display panel DP may include a plane defined by a first direction DR1 and a second direction DR2 crossing the first direction DR1. The display panel DP may have a rectangular shape with long sides in the first direction DR1 and short sides in the second direction DR2, however, the shape of the display panel DP is not limited thereto.

A direction perpendicularly crossing the plane defined by the first and second directions DR1 and DR2 may be referred to as a “third direction DR3”. In the disclosure, the expression “when viewed in a plan view” may mean a state of looking at the display panel DP from above the display panel DP, i.e., a state of being viewed in the third direction DR3.

The display panel DP may include a first substrate SUB1, a second substrate SUB2, and a liquid crystal layer (not shown) interposed between the first substrate SUB1 and the second substrate SUB2. The display panel DP may display an image by controlling a light transmittance using liquid crystal molecules in the liquid crystal layer.

The display panel DP may include a display area DA displaying the image and a non-display area NDA surrounding the display area DA, which may be defined in the plane of the display panel DP. Although not shown in figures, pixels may be disposed in the display area DA to display the image. The non-display area NDA may not display the image, and drivers (not shown) may be disposed in the non-display area NDA to drive the pixels.

The backlight member BLU may be disposed under the display panel DP to provide a light to the display panel DP. The pixels of the display panel DP may display the image using the light provided from the backlight member BLU. The bottom chassis BS and the top chassis TS may accommodate and protect the backlight member BLU and the display panel DP.

The backlight member BLU may include an optical part OP, a light source part LP, fixing parts FI, and a reflective sheet RS. The optical part OP may include an optical sheet OS and a diffusion plate DFP. The optical sheet OS may be disposed under the display panel DP, and the diffusion plate DFP may be disposed under the optical sheet OS. The light source part LP and the reflective sheet RS may be disposed under the diffusion plate DFP.

The light generated by the light source part LP may be provided to the diffusion plate DFP. The diffusion plate DFP may diffuse the light provided from the light source part LP. The diffusion plate DFP may be a structure harder than the optical sheet OS. To diffuse the light, a diffusing agent may be distributed inside the diffusion plate DFP, or a diffusion agent film may be coated on a surface of the diffusion plate DFP. The light diffused by the diffusion plate DFP may be provided to the optical sheet OS.

The optical sheet OS may collect the light diffused by the diffusion plate DFP and may provide the collected light to the display panel DP. Although not shown in figures, the optical sheet OS may include a diffusion sheet, a prism sheet disposed on the diffusion sheet, and a protective sheet disposed on the prism sheet.

The diffusion sheet may diffuse the light provided from the diffusion plate DFP. The prism sheet may collect the light diffused by the diffusion sheet in the third direction DR3. The light exiting from the prism sheet may travel in an upward direction. As a result, light having a uniform brightness distribution may be provided to the display panel DP. The protective sheet may protect the prism sheet that may be vulnerable to being scratched.

The light source part LP may be disposed under the reflective sheet RS. The light source part LP may include light source substrates LSB and light sources LU respectively disposed (e.g. mounted) on the light source substrates LSB.

The light source substrates LSB may have a rectangular shape with short sides in the first direction DR1 and long sides in the second direction DR2. The light source substrates LSB may be disposed on a bottom portion BP of the bottom chassis BS and may be disposed in the first and second directions DR1 and DR2. However, the number of the light source substrates LSB disposed in the first and second directions DR1 and DR2 may be changed in various ways depending on a size and a shape of the display panel DP.

In the embodiment, the light source substrates LSB may include insulating substrates formed of various materials. For example, the light source substrates LSB may include a glass material, however, they are not limited thereto. As another example, the light source substrates LSB may include a variety of plastic materials.

The light sources LU may be disposed (e.g. mounted) on upper surfaces of the light source substrates LSB. As an example, the light sources LU may be disposed in the first and second directions DR1 and DR2 and may be spaced apart from each other at regular intervals. Each of the light sources LU may include a light emitting diode. Light generated by the light sources LU may be provided to the diffusion plate DFP.

The light source substrates LSB disposed on the bottom chassis BS may be fixed to the bottom chassis BS by fixing parts FI disposed between the light source substrates LSB. This configuration will be described in detail later.

First insertion holes IH1 that may overlap the light sources LU and second insertion holes IH2 that may overlap the fixing parts FI may be defined through the reflective sheet RS. As an example, when viewed in a plan view, the first insertion holes IH1 may have a circular shape, and the second insertion holes IH2 may have a quadrangular shape. However, the shapes of the first and second insertion holes IH1 and IH2 may be changed depending on the shape of elements inserted therein.

The reflective sheet RS may be disposed on the light source substrates LSB, the light sources LU may be inserted into the first insertion holes IH1, and portions of the fixing parts FI may be inserted into the second insertion holes IH2. The reflective sheet RS may reflect light exiting from the light sources LU to a rear-side direction such that the reflected light travels to the diffusion plate DFP.

The bottom chassis BS may accommodate the backlight member BLU. The bottom chassis BS may include the bottom portion BP, a first sidewall portion SW1, a horizontal extension portion HE, and a second sidewall portion SW2. The bottom portion BP may include a plane defined by the first and second directions DR1 and DR2. The bottom portion BP may have a rectangular shape with long sides in the first direction DR1 and short sides in the second direction DR2.

The bottom portion BP may be provided with recesses RE defined therein. The number of the recesses RE may correspond to the number of the fixing parts FI. The recesses RE may be defined by taking into account positions of the light source substrates LSB disposed on the bottom portion BP. The recesses RE may be recessed downward from an upper surface of the bottom portion BP. When viewed in a plan view, the recesses RE may have a quadrangular shape. Second holes H2 may be defined in the recesses RE. As an example, the second holes H2 may have a quadrangular shape in a plan view.

The first sidewall portion SW1 may extend upward from a boundary of the bottom portion BP. The first sidewall portion SW1 may include a slant surface that may be bent upward at an angle with respect to the bottom portion BP. The horizontal extension portion HE may extend from an upper end of the first sidewall portion SW1 in a direction substantially parallel to the bottom portion BP. The second sidewall portion SW2 may extend upward from a boundary of the horizontal extension portion HE to be perpendicular to the horizontal extension portion HE.

The top chassis TS may be disposed on the display panel DP. The top chassis TS may have a frame shape. The top chassis TS may be provided with an opening defined therethrough to expose the display area DA.

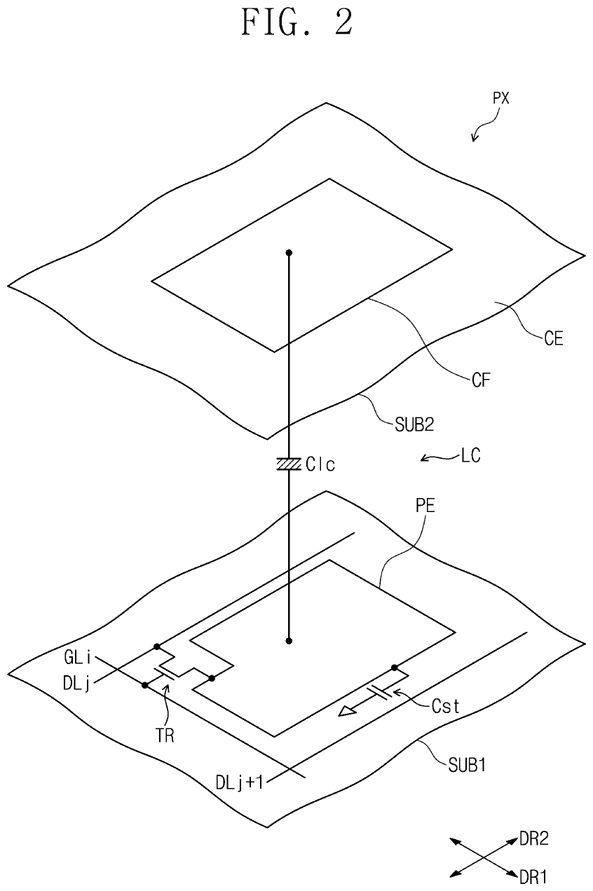

FIG. 2 is a view schematically showing a pixel of the display panel DP shown in FIG. 1.

Referring to FIG. 2, the pixel PX may include a transistor TR connected to a gate line GLi and a data line DLj, a liquid crystal capacitor Clc connected to the transistor TR, and a storage capacitor Cst connected to the liquid crystal capacitor Clc in parallel. The storage capacitor Cst may be omitted. Each of “i” and “j” may be a natural number.

The transistor TR may be disposed on the first substrate SUB1. The transistor TR may include a gate electrode (not shown) connected to the gate line GLi, a source electrode (not shown) connected to the data line DLj, and a drain electrode (not shown) connected to the liquid crystal capacitor Clc and the storage capacitor Cst.

The liquid crystal capacitor Clc may include a pixel electrode PE disposed on the first substrate SUB1, a common electrode CE disposed on the second substrate SUB2, and a liquid crystal layer LC interposed between the pixel electrode PE and the common electrode CE. The liquid crystal layer LC may serve as a dielectric substance. The pixel electrode PE may be connected to the drain electrode of the transistor TR.

In FIG. 2, the pixel electrode PE may have a non-slit structure, however, it is not limited thereto. As an example, the pixel electrode PE may have a slit structure that includes a trunk portion having a cross shape and branch portions extending radially from the trunk portion.

The common electrode CE may be disposed on an entire lower surface of the second substrate SUB2, however, it is not limited thereto. The common electrode CE may be disposed on the first substrate SUB1. At least one of the pixel electrode PE and the common electrode CE may include the slit.

The storage capacitor Cst may include the pixel electrode PE, a storage electrode (not shown) branched from a storage line (not shown), and an insulating layer interposed between the pixel electrode PE and the storage electrode. The storage line may be disposed on the first substrate SUB1 and may be substantially simultaneously formed with gate line GLi on the same layer. The storage electrode may partially overlap the pixel electrode PE.

The pixel PX may further include a color filter CF that may display a red color, a green color, or a blue color. As an example, the color filter CF may be disposed on the second substrate SUB2 as shown in FIG. 2, however, it is not limited thereto. That is, the color filter CF may be disposed on the first substrate SUB1.

The transistor TR may be turned on in response to a gate signal that may be applied thereto through the gate line GLi. A data voltage that may be provided through the data line DLj may be provided to the pixel electrode PE of the liquid crystal capacitor Clc through the turned-on transistor TR. The common electrode CE may receive a common voltage.

An electric field may be formed between the pixel electrode PE and the common electrode CE due to a difference in voltage level between the data voltage and the common voltage. The liquid crystal molecules of the liquid crystal layer LC may be driven by the electric field formed between the pixel electrode PE and the common electrode CE. Light transmittance may be controlled by the liquid crystal molecules driven by the electric field, and thus, the image may be displayed.

The storage line may receive a storage voltage having a constant voltage level, however, it is not limited thereto. The storage line may receive the common voltage. The storage capacitor Cst may compensate for an amount of charge of the liquid crystal capacitor Clc.

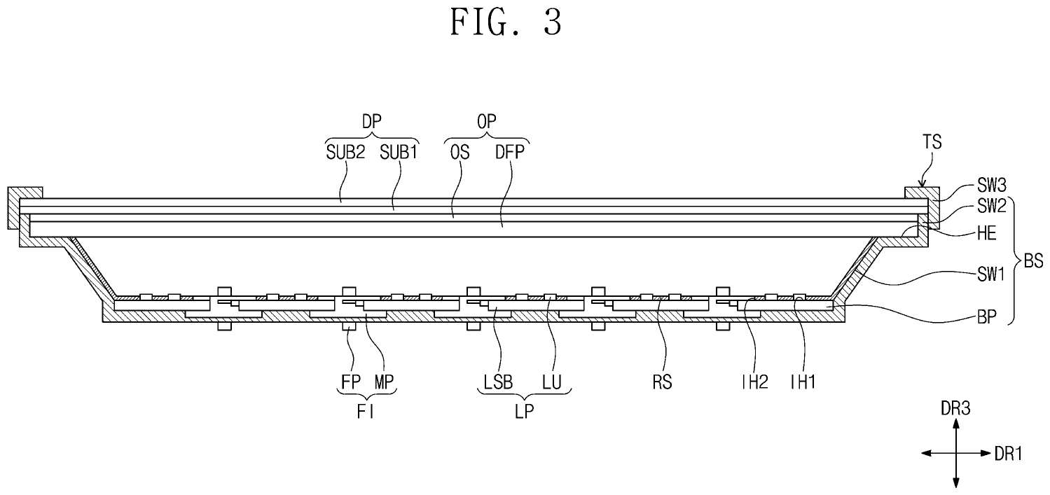

FIG. 3 is a schematic cross-sectional view taken along line I-I′ shown in FIG. 1.

Referring to FIG. 3, the light source part LP, the reflective sheet RS, and the optical part OP may be accommodated in the bottom chassis BS. The light source substrates LSB may be disposed on the bottom portion BP. The reflective sheet RS may be disposed on the first sidewall portion SW1 of the bottom chassis BS and the light source substrates LSB. The light sources LU may be inserted into the first insertion holes IH1 of the reflective sheet RS, and the upper portions of the fixing parts FI may be inserted into the second insertion holes IH2 of the reflective sheet RS.

The optical part OP may be disposed on the reflective sheet RS. In detail, the diffusion plate DFP may be disposed on the reflective sheet RS, and an edge of the diffusion plate DFP may be disposed on the horizontal extension portion HE. Since the edge of the diffusion plate DFP is disposed on the horizontal extension portion HE, a space may be defined between the diffusion plate DFP and the bottom portion BP. Accordingly, the light sources LU may be spaced apart from the diffusion plate DFP. Although not shown in figures, supporters may be disposed between the light source substrates LSB and the diffusion plate DFP to support the diffusion plate DFP.

The optical sheet OS may be disposed between the diffusion plate DFP and the display panel DP. The diffusion plate DFP may have a rigid structure, and the optical sheet OS may have a thin and flexible property. The diffusion plate DFP may support the optical sheet OS, and thus, the optical sheet OS may be kept flat.

Side surfaces of the diffusion plate DFP and the optical sheet OS may be disposed adjacent to inner side surfaces of the second sidewall portion SW2. A height of an upper surface of the optical sheet OS may be substantially the same as a height of an upper surface of the second sidewall portion SW2. The display panel DP may be disposed on the optical sheet OS and the second sidewall portion SW2.

The top chassis TS may include a third sidewall portion SW3 extending in the third direction DR3 and disposed adjacent to an outer side surface of the second sidewall portion SW2.

The light source substrates LSB may be disposed on and fixed to portions of the bottom chassis BS by the fixing parts FI. Each of the fixing parts FI may include a main portion MP and a fixing pin FP engaged with the main portion MP. The main portions MP may fix the light source substrates LSB, and the fixing pins FP may fix the main portions MP to the bottom chassis BS. The main portion MP and the fixing pin FP will be described in detail below.

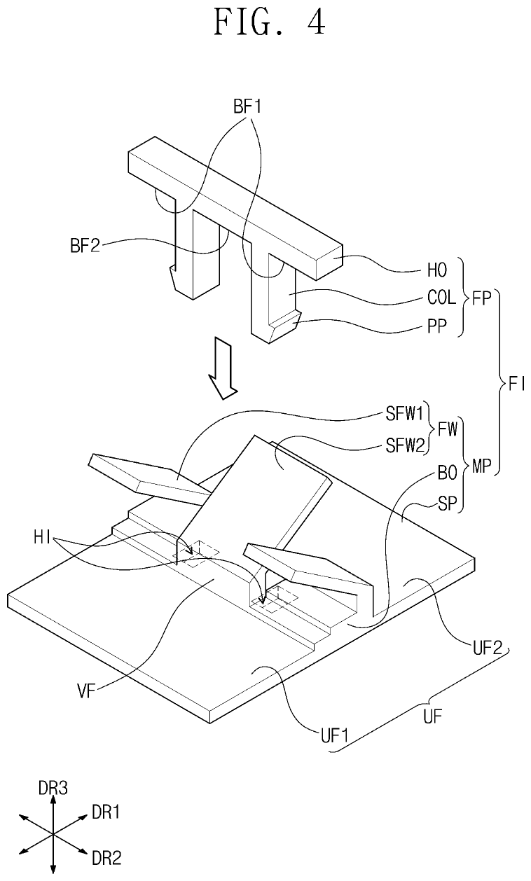

FIG. 4 is a schematic perspective view showing a configuration of a fixing part shown in FIG. 1.

FIG. 4 shows a fixing part FI as a representative example, and other fixing parts FI shown in FIG. 1 may have substantially the same structure as that of the fixing part FI shown in FIG. 4.

Referring to FIG. 4, the fixing part FI may include the main portion MP and the fixing pin FP that may be engaged with the main portion MP. The main portion MP may include a supporter SP, a body BO, and wings FW. The supporter SP may define a lower portion of the main portion MP. The supporter SP may have a plate shape. The supporter SP may be disposed in one of the recesses RE of the bottom chassis BS shown FIG. 1. The supporter SP may have a height, i.e., a length in the third direction DR3 of the supporter, that may be substantially the same as a depth of the recesses RE.

The body BO may protrude upward from a portion of the supporter SP. As an example, the body BO may protrude upward from a center portion of the supporter SP. The body BO may extend in the second direction DR2. An upper surface UF of the supporter SP may include a first upper surface UF1 and a second upper surface UF2 by the body BO. The body BO may include both side surfaces VF opposite to each other in the first direction DR1.

The wings FW may extend upward from the body BO. The wings FW may include first sub-wings SFW1 extending to the first upper surface UF1 from the body BO and a second sub-wing SFW2 extending to the second upper surface UF2 from the body BO. In the embodiment, the wings FW include two first sub-wings SFW1 and one second sub-wing SFW2 disposed between the first sub-wings SFW1, however, the number of the first sub-wings SFW1, the number of the second sub-wings SFW2, and arrangements of the first and second sub-wings SFW1 and SFW2 are not limited thereto.

The wings FW may include a material having a lower rigidity and an elasticity. As an example, the wings FW may include silicone, rubber, urethane, or the like, or a combination thereof. Accordingly, in case that an external force may be applied to the wings FW, the shape of the wings FW may be deformed. In case that the external force applied to the wings FW may be released, the wings FW may be restored to their original shape.

The first sub-wings SFW1 and the second sub-wing SFW2 may be spaced apart from each other by a distance in the second direction DR2. Two first holes H1 may be defined between the first sub-wings SFW1 and the second sub-wing SFW2. When viewed in a plan view, the first holes H1 may have a quadrangular shape. However, the number and shape of the first holes H1 are not limited thereto, and the number and shape of the first holes H1 may be changed depending on a shape of the fixing pin described below.

In the first embodiment of the disclosure, the supporter SP, the body BO, and the wings FW may be integrally formed with each other, however, they are not limited thereto. The supporter SP, the body BO, and the wings FW may be connected to each other after being separately manufactured.

The fixing pin FP may include a horizontal portion HO and column portions COL. The horizontal portion HO may have a bar shape extending in the second direction DR2. A lower surface of the horizontal portion HO may include a first lower surface BF1 and a second lower surface BF2.

The column portions COL may extend downward from the horizontal portion HO. The column portions COL may be disposed to overlap portions at which the first holes H1 may be defined in the main portion MP. In an embodiment, two column portions COL may be provided, however, the number of the column portions is not limited to two.

Each of the fixing parts FI may include protrusion portions PP extending in the second direction from lower ends of the column portions COL. The protrusion portions PP of the two column portions COL may protrude in opposite directions to each other. A width, i.e., a width in the second direction DR2, of a portion including the protrusion portions PP at the lower ends of the column portions COL may be greater than a width of the first holes H1 of the main portion MP and the second holes H2 of the bottom chassis BS. The protrusion portions PP may include a material having an elasticity, and thus may be inserted into the first holes H1. However, the shape of the protrusion portions is not limited to that shown in FIG. 4. As an example, the protrusion portions may have a hook shape such as that of a fish hook.

The wings FW and an upper portion, e.g., the horizontal portion HO, of the fixing pin FP may be inserted into the second insertion holes IH2 of the reflective sheet RS as shown in FIG. 3. A portion of the light generated by the light sources LU may reach the wings FW and the upper portion of the fixing pin FP. In an embodiment, the fixing part FI may have a color having a high reflectance.

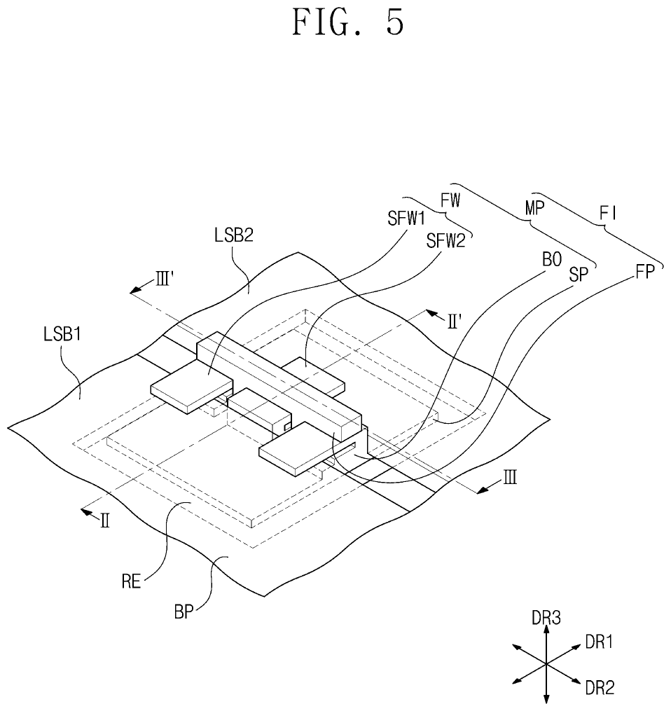

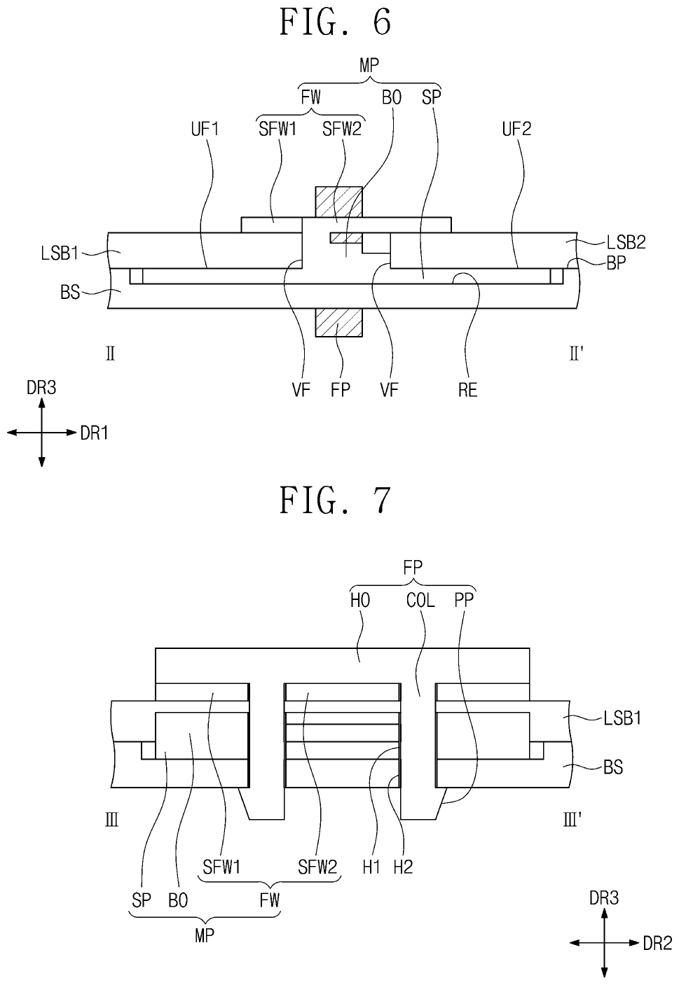

FIG. 5 is a schematic perspective view showing the light source substrates that may be fixed to the bottom chassis by the fixing part shown in FIG. 4, FIG. 6 is a schematic cross-sectional view taken along line II-IF shown in FIG. 5, and FIG. 7 is a schematic cross-sectional view taken along line shown in FIG. 5.

For the convenience of explanation, components disposed under the light source substrates LSB may be indicated by a dotted line. Hereinafter, the light source substrate disposed at a left side in FIGS. 5 to 7 will be referred to as a first light source substrate LSB1, and the light source substrate disposed at a right side in FIGS. 5 to 7 will be referred to as a second light source substrate LSB2.

Referring to FIGS. 5 to 7, the supporter SP of the fixing part FI may be disposed in the recess RE of the bottom chassis BS. The supporter SP may be attached and fixed to the recess RE by using a double-sided tape or a chemical adhesive. As described above, the height of the supporter SP may be substantially the same as the height of the recess RE. Therefore, the upper surfaces UF1 and UF2 of the supporter SP may be positioned on the same plane as the bottom portion BP of the bottom chassis BS. However, the height of the supporter SP may be different (e.g., smaller) than the height of the recess RE.

The first light source substrate LSB1 may be disposed on the first upper surface UF1 and the bottom portion BP adjacent to the first upper surface UF1. The second light source substrate LSB2 may be disposed on the second upper surface UF2 and the bottom portion BP adjacent to the second upper surface UF2.

The body BO may be disposed between the first light source substrate LSB1 and the second light source substrate LSB2. The side surface of the first light source substrate LSB1 and the side surface of the second light source substrate LSB2 may be disposed respectively adjacent to the both side surfaces VF of the body BO.

As described above, the light source substrates LSB may be disposed at positions defined by the upper surfaces UF1 and UF2 of the supporter SP and the both side surfaces VF of the body BO. Thus, the fixing part FI may provide the positions of the light source substrates LSB.

The wings FW may be disposed on the light source substrates LSB1 and LSB2. The shape of the wings FW may be changed by the fixing pin FP. In detail, as the fixing pin FP may be engaged with the main portion MP, the first lower surface BF1 of the fixing pin FP may press the first sub-wings SFW1 in a downward direction (or in the third direction DR3), and the second lower surface BF2 may press the second sub-wing SFW2 in the downward direction. Shapes of the first sub-wings SFW1 and the second sub-wing SFW2 may be changed to be substantially parallel to the first light source substrate LSB1 and the second light source substrate LSB2, respectively. The first sub-wings SFW1 may make contact with the upper surface of the first light source substrate LSB1 to fix the first light source substrate LSB1. The second sub-wing SFW2 may make contact with the upper surface of the second light source substrate LSB2 to fix the second light source substrate LSB2. The first and second sub-wings SFW1 and SFW2 may have a low rigidity. Accordingly, the first and second light source substrates LSB1 and LSB2 may not be damaged by the first and second sub-wings SFW1 and SFW2.

The column portions COL of the fixing pin FP may pass through the first holes H1 of the main portion MP and the second holes H2 of the bottom chassis BS. Since the protrusion portions PP have the elasticity, the protrusion portions PP may pass through the first holes H1 and the second holes H2. The protrusion portions PP may be restored to their original shape after passing through the second holes H2. The protrusion portions PP may be fixed to the lower surface of the bottom chassis BS.

As described above, the light source substrates LSB may be fixed to the main portion MP by the wings FW, and the main portion MP may be fixed to the bottom chassis BS by the fixing pin FP. Consequently, the light source substrate LSB may be fixed to the bottom chassis BS. As described above, the light source substrates LSB may be easily disposed on and fixed to the bottom chassis BS by the fixing parts FI.

Fixed light source substrates LSB may be separated from the bottom chassis BS. In detail, in case that a user contracts the protrusion portions PP and lifts the fixing pin FP upwards, the fixing pin FP may be separated from the bottom chassis BS and the main portion MP. Accordingly, the shape of the wings FW may be restored, and the force fixing the light source substrates LSB may be released. As described above, fixed light source substrates LSB may be separated from the bottom chassis BS by operating the fixing pin FP.

Consequently, the light source substrates LSB may be easily fixed to and may be easily separated from the bottom chassis BS by the fixing part FI.

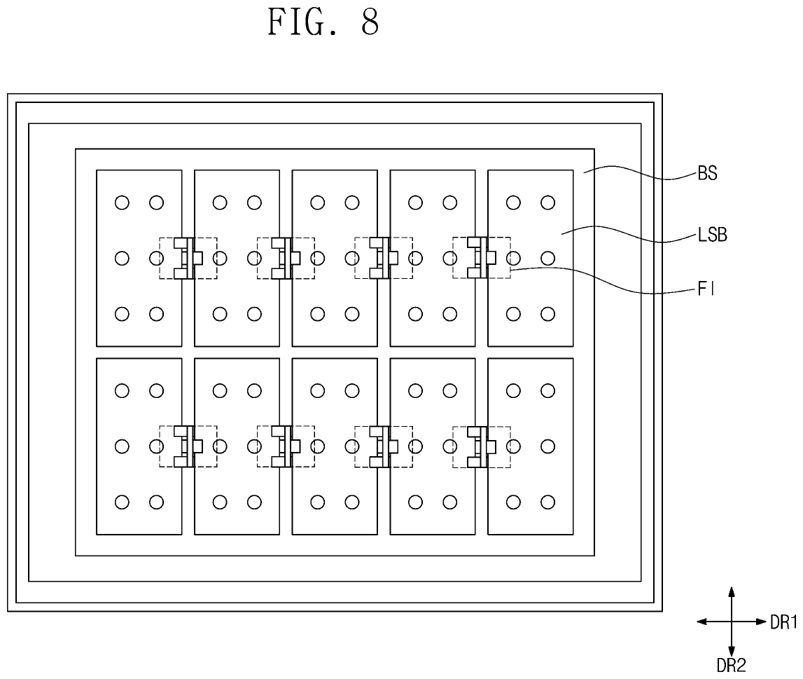

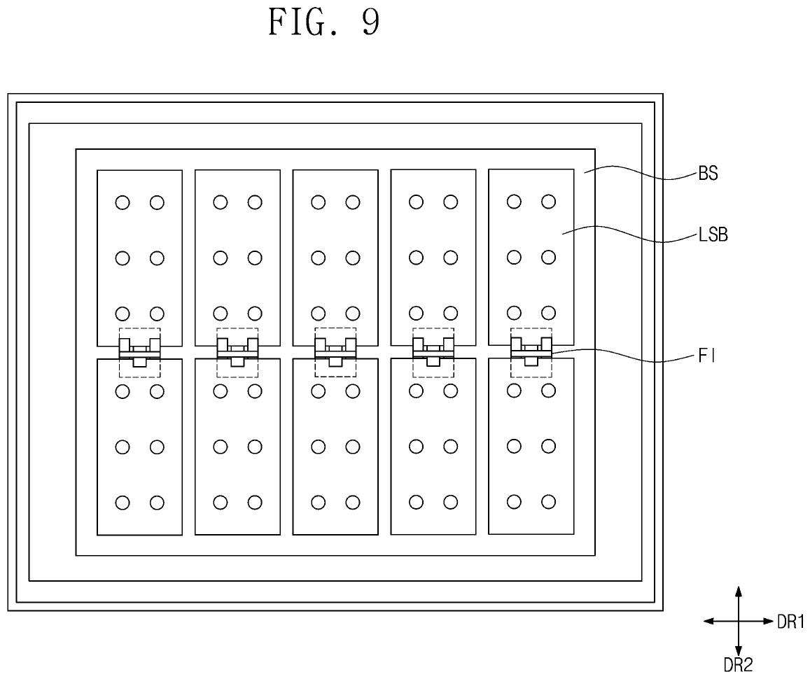

FIGS. 8 and 9 are schematic plan views showing the fixing parts that may be disposed between the light source substrates in the display device according to the first embodiment of the disclosure.

FIGS. 8 and 9 show the light source substrates LSB disposed on the bottom chassis BS. For the convenience of explanation, ten light source substrates LSB are shown in FIGS. 8 and 9. However, more than ten light source substrates LSB may be disposed on the bottom chassis BS. In FIGS. 14, 15, and 20, ten light source substrates LSB will be also shown as a representative example.

Referring to FIG. 8, the light source substrates LSB may be disposed in the first direction DR1 and the second direction DR2. One fixing part FI may fix two light source substrates LSB adjacent to each other. The fixing parts FI may be disposed between a K-th light source substrate LSB and a (K+1)th light source substrate LSB, which may be disposed in the first direction DR1. That is, the fixing parts FI may be disposed between the long sides of the two light source substrates LSB adjacent to each other.

Referring to FIG. 9, the fixing parts FI may be disposed between a K-th light source substrate LSB and a (K+1)th light source substrate LSB, which may be disposed in the second direction DR2. That is, the fixing parts FI may be disposed between the short sides of the two light source substrates LSB adjacent to each other.

Although not shown in figures, the fixing parts FI may be disposed between the long sides and between the short sides of the light source substrates LSB adjacent to each other.

Hereinafter, a fixing part having a different shape will be described. In the following descriptions, features of the fixing part, which may be different from the features of the above-described fixing part FI, will be described. The same elements will be assigned with the same reference numerals.

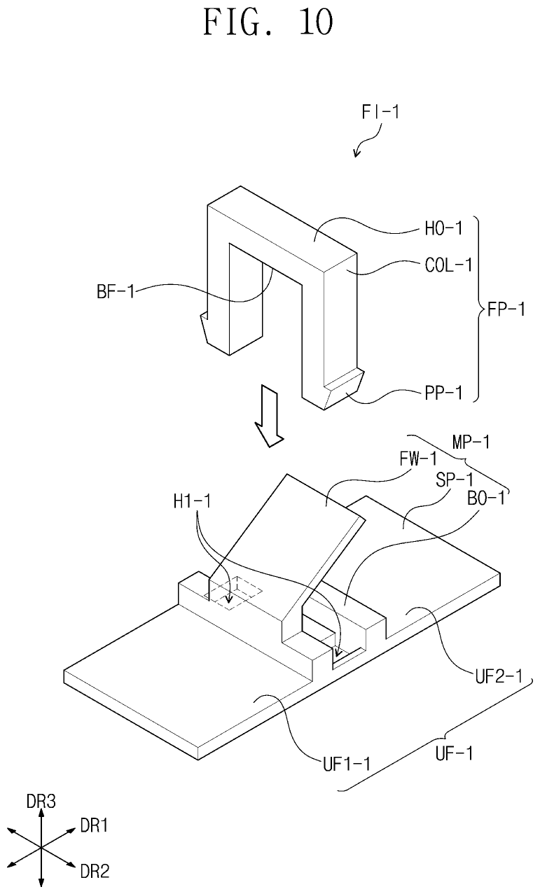

FIG. 10 is a schematic perspective view showing a configuration of a fixing part of a display device according to a second embodiment of the disclosure.

Referring to FIG. 10, a fixing part FI-1 may include a main portion MP-1 and a fixing pin FP-1 engaged with the main portion MP-1.

According the second embodiment, a wing FW-1 may extend in one direction. In detail, the wing FW-1 may extend to a second upper surface UF2-1 from an upper portion of a body BO-1, however, it is not limited thereto. The wing FW-1 may extend to a first upper surface UF1-1 from the upper portion of the body BO-1. The wing FW-1 may include a material having a low rigidity and an elasticity.

Two first holes H1-1 may be defined through the main portion MP-1. The first holes H1-1 may be spaced apart from each other in the second direction. The wing FW-1 may be disposed between the first holes H1-1. When viewed in a plan view, the first holes H1-1 may have a quadrangular shape.

A fixing pin FP-1 may include a horizontal portion HO-1 and two column portions COL-1. The horizontal portion HO-1 may extend in the second direction DR2. The column portions COL-1 may extend downward from the horizontal portion HO-1. The column portions COL-1 may be disposed to overlap positions at which the first holes H1-1 of the main portion MP-1 may be defined.

Each of the fixing parts FI-1 may include protrusion portions PP-1 protruding in the second direction from lower ends of the column portions COL-1. The protrusion portions PP-1 may include a material having an elasticity.

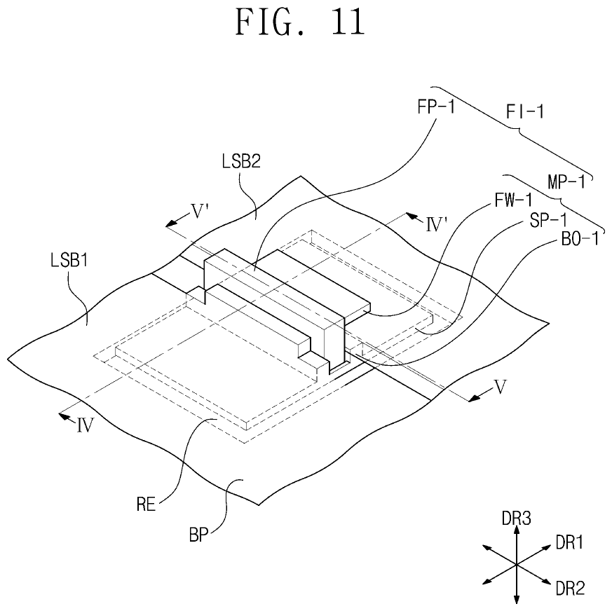

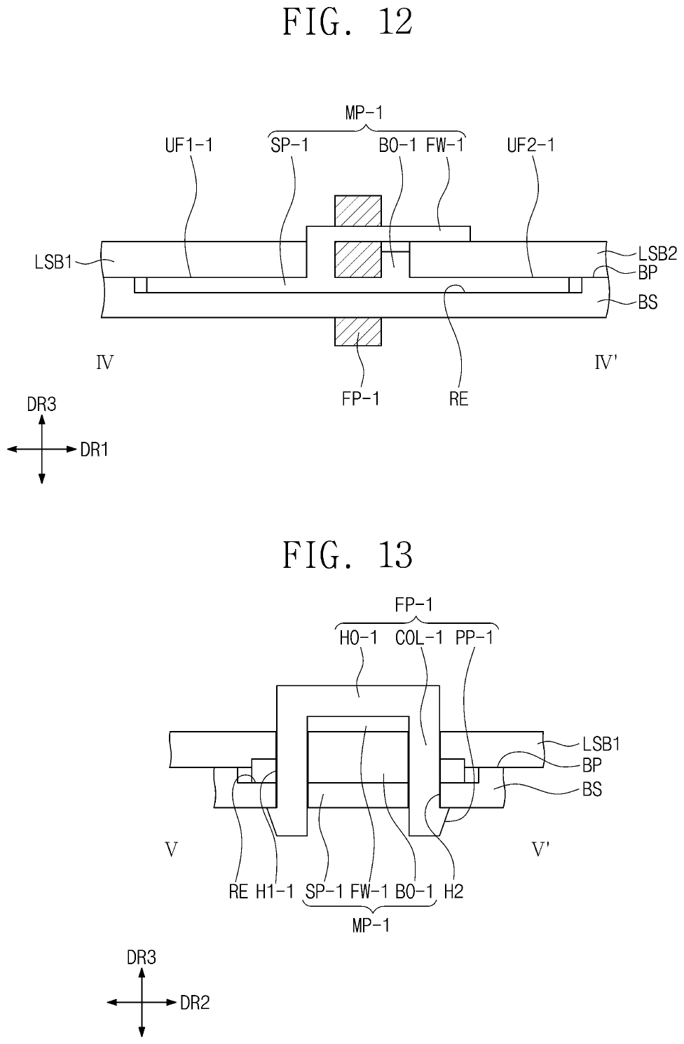

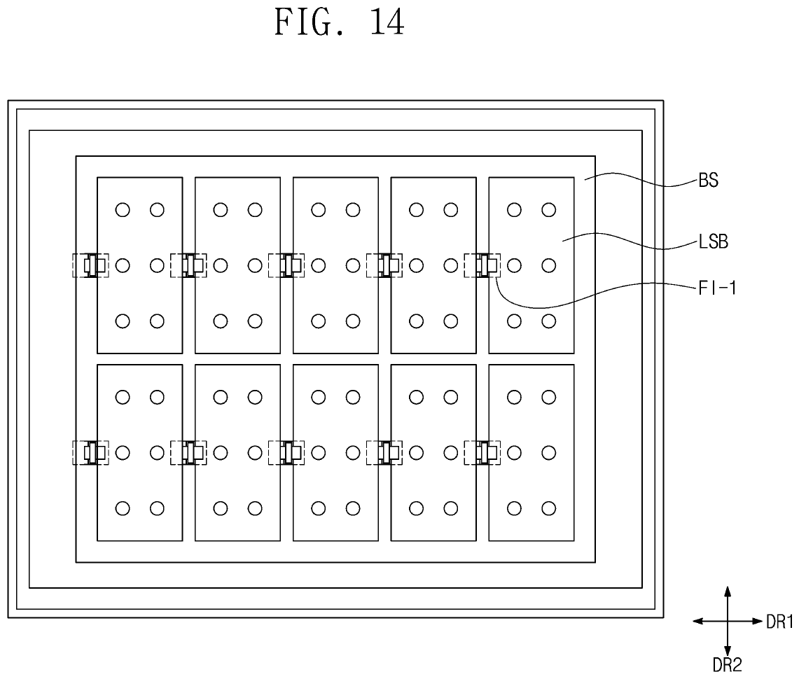

FIG. 11 is a schematic perspective view showing light source substrates that may be fixed to a bottom chassis by the fixing part shown in FIG. 10. FIG. 12 is a schematic cross-sectional view taken along line IV-IV′ shown in FIG. 11. FIG. 13 is a schematic cross-sectional view taken along line V-V′ shown in FIG. 11.

Referring to FIGS. 11 to 13, a supporter SP-1 of the fixing part FI-1 may be disposed in a recess RE of a bottom chassis BS. A first light source substrate LSB1 may be disposed on the first upper surface UF1-1 and a bottom portion BP adjacent to the first upper surface UF1-1. A second light source substrate LSB2 may be disposed on the second upper surface UF2-1 and the bottom portion BP adjacent to the second upper surface UF2-1. The body BO-1 may be disposed between the first light source substrate LSB1 and the second light source substrate LSB2. The supporter SP-1 and the body BO-1 may provide an arrangement of the light source substrates LSB1 and LSB2.

The wing FW-1 may be disposed on the second light source substrate LSB2. The shape of the wing FW-1 may be changed by the fixing pin FP-1. In detail, as the fixing pin FP-1 may be engaged with the main portion MP-1, a lower surface BF-1 of the fixing pin FP-1 may press the wing FW-1 in a downward direction. The shape of the wing FW-1 may be changed to be substantially parallel to the second light source substrate LSB2. The wing FW-1 may make contact with the upper surface of the second light source substrate LSB2 to fix the second light source substrate LSB2. Since the wing FW-1 has a low rigidity and an elasticity, the second light source substrate LBS2 may not be damaged.

The column portions COL-1 of the fixing pin FP-1 may pass through the first holes H1-1 of the main portion MP-1 and second holes H2 of the bottom chassis BS. Since the protrusion portions PP-1 have elasticity, the protrusion portions PP-1 may pass through the first holes H1-1 and the second holes H2. The protrusion portions PP-1 may be restored to their original shape after passing through the second holes H2. The protrusion portions PP-1 may be fixed to the lower surface of the bottom chassis BS.

As described above, the light source substrates LSB1 and LSB2 may be easily disposed on the bottom chassis BS by the fixing part FI-1. A light source substrate, e.g., the second light source substrate LSB2, of the light source substrates LSB1 and LSB2 may be fixed to the bottom chassis BS.

The fixed light source substrate LSB may be separated from the bottom chassis BS by removing the fixing pin FP-1 from the main portion MP-1. In detail, in case that the fixing pin FP-1 may be removed, the wing FW-1 may be restored to its original shape, and the force fixing the second light source substrate LSB2 may be released. Therefore, the second light source substrate LSB2 may be separated from the bottom chassis BS.

FIG. 14 is a schematic plan view showing an arrangement of the fixing parts disposed between the light source substrates in the display device according to the second embodiment of the disclosure.

Referring to FIG. 14, the light source substrates LSB may be disposed in the first and second directions DR1 and DR2. In an embodiment, since the fixing parts FI-1 may include a single wing, one fixing part FI-1 may fix one light source substrate LSB. Among the fixing parts FI-1, some fixing parts FI-1 may be disposed between the edge of the bottom portion BP and the light source substrates LSB. The other fixing parts FI-1 may be disposed between the long sides of the light source substrates LSB adjacent to each other. When viewed in a plan view, the fixing parts FI-1 may fix the light source substrate LSB disposed at a right side thereof.

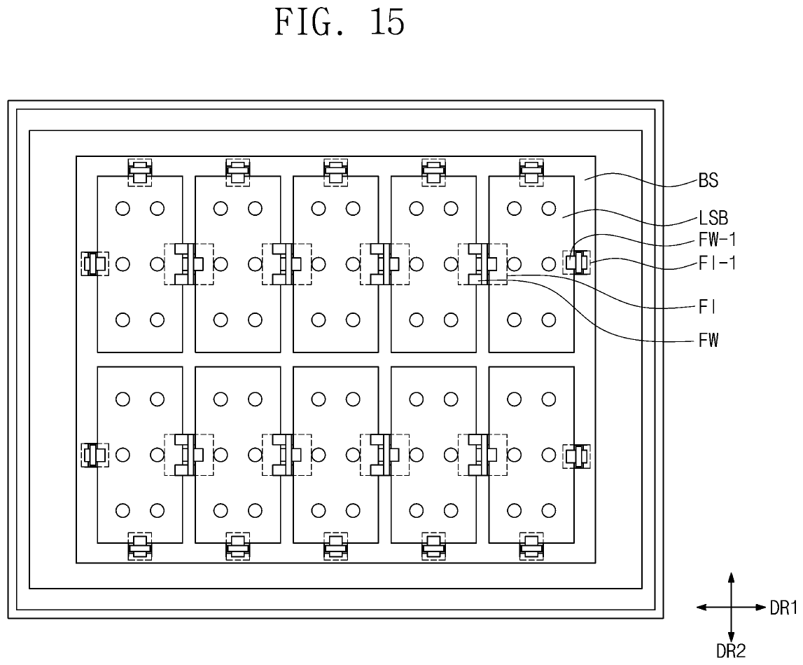

FIG. 15 is a schematic plan view showing fixing parts disposed between light source substrates in a display device according to a third embodiment of the disclosure.

Referring to FIG. 15, light source substrates LSB may be fixed to a bottom chassis BS by fixing parts FI and fixing parts FI-1. Each of the fixing parts FI may be substantially the same as the fixing part shown in FIG. 4 according to the first embodiment of the disclosure. The fixing parts FI-1 may be substantially the same as the fixing part shown in FIG. 10 according to the second embodiment of the disclosure.

As an example, the fixing parts FI may be disposed between long sides of the light source substrates LSB adjacent to each other. Wings FW of the fixing parts FI may fix the light source substrates LSB adjacent to each other. The fixing parts FI-1 may be disposed between an edge of a bottom portion BP and the light source substrates LSB. Wings FW-1 of the fixing parts FI-1 may fix the light source substrates adjacent to the edge.

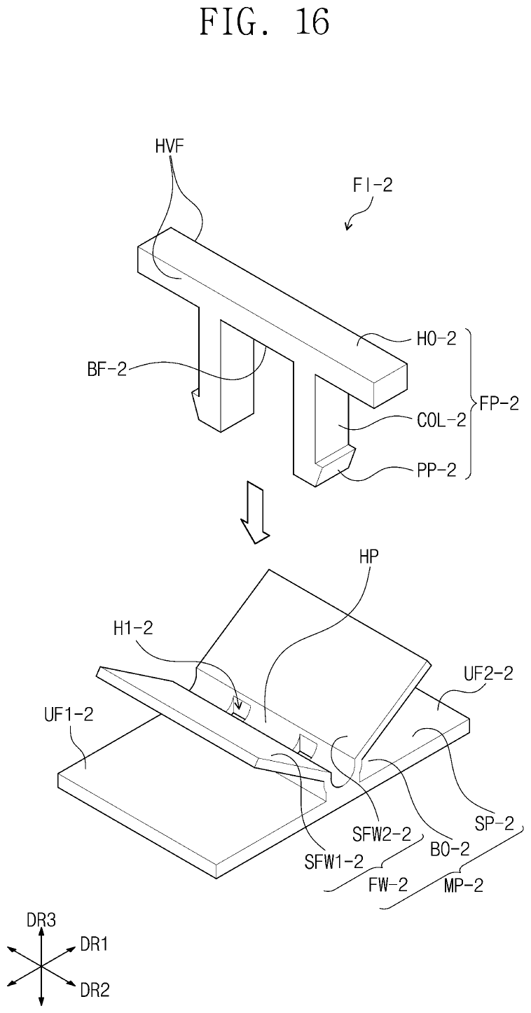

FIG. 16 is a schematic perspective view showing a configuration of a fixing part of a display device according to a fourth embodiment of the disclosure.

Referring to FIG. 16, a fixing part FI-2 may include a main portion MP-2 and a fixing pin FP-2 engaged with the main portion MP-2.

According to the fourth embodiment of the disclosure, wings FW-2 may include a first sub-wing SFW1-2 extending to a first upper surface UF1-2 from a body BO-2 and a second sub-wing SFW2-2 extending to a second upper surface UF2-2 from the body BO-2. The first sub-wing SFW1-2 and the second sub-wing SFW2-2 may be spaced apart from each other by a distance in the first direction DR1.

A groove HP may be defined between the first sub-wing SFW1-2 and the second sub-wing SFW2-2. The groove HP may have a groove shape extending in the second direction DR2. Wings FW-2 may include a material having a low rigidity and an elasticity. Accordingly, the shape of the groove HP may be changed by an object inserted therein.

Two first holes H1-2 may be defined in the groove HP. The first holes H1-2 may be spaced apart from each other in the second direction. When viewed in a plan view, the first holes H1-2 may have a quadrangular shape.

The fixing pin FP-2 may include a horizontal portion HO-2 and column portions COL-2 extending downward from the horizontal portion HO-2. The horizontal portion HO-2 may include side surfaces HVF opposite to each other in the first direction. The side surfaces HVF may be substantially parallel to the third direction DR3. The column portions COL-2 may be disposed to overlap positions at which the first holes H1-2 may be defined.

The fixing pin FP-2 may include protrusion portions PP-2 protruding from lower ends of the column portions COL-2 to the second direction. The protrusion portions PP-2 may include a material having an elasticity.

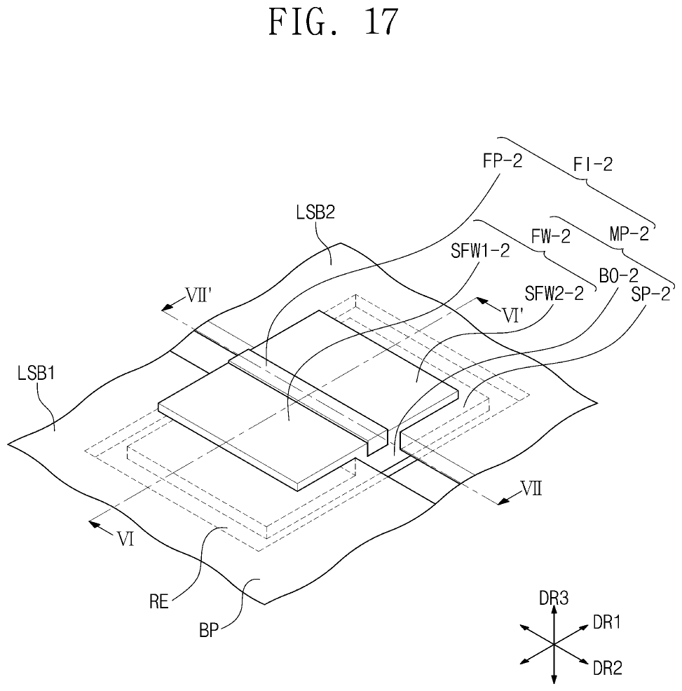

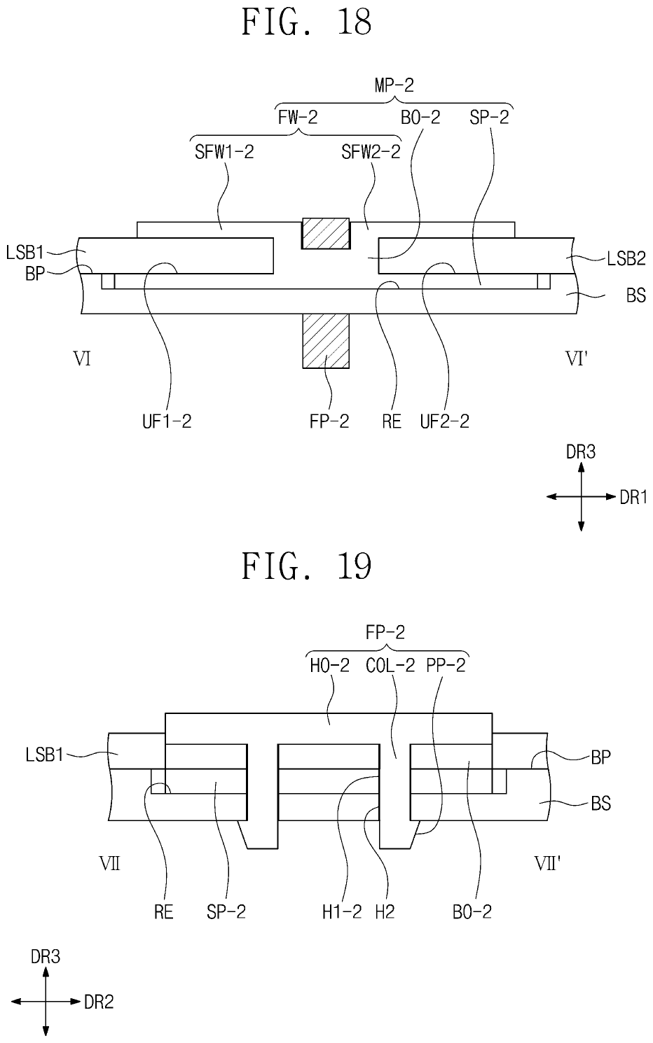

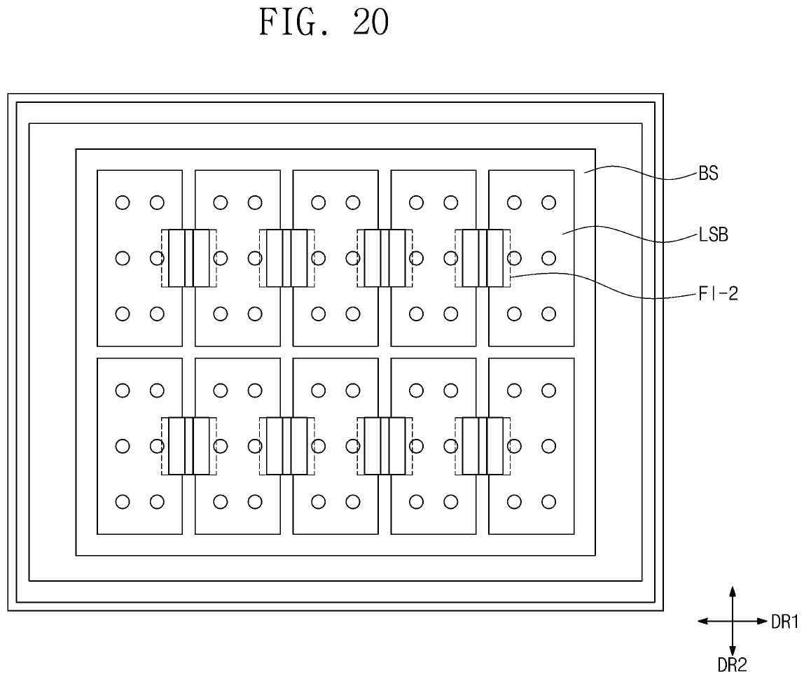

FIG. 17 is a schematic perspective view showing light source substrates fixed to a bottom chassis by the fixing part shown in FIG. 16. FIG. 18 is a schematic cross-sectional view taken along line VI-VI′ shown in FIG. 17. FIG. 19 is a schematic cross-sectional view taken along line VII-VII′ shown in FIG. 17.

Referring to FIGS. 17 to 19, a supporter SP-2 of the fixing part FI-2 may be disposed in a recess RE of the bottom chassis BS. A first light source substrate LSB1 may be disposed on the first upper surface UF1-2 and a bottom portion BP adjacent to the first upper surface UF1-2. A second light source substrate LSB2 may be disposed on the second upper surface UF2-2 and the bottom portion BP adjacent to the second upper surface UF2-2. The body BO-2 may be disposed between the first light source substrate LSB1 and the second light source substrate LSB2.

The wings FW-2 may be disposed on the first and second light source substrates LSB1 and LSB2. The shape of the wings FW-2 may be changed by the fixing pin FP-2. In detail, as the fixing pin FP-2 is engaged with the main portion MP-2, the horizontal portion HO-2 may be inserted into the groove HP. The shape of the groove HP may be changed to correspond to the shape of the horizontal portion HO-2. As the shape of the groove HP may be changed, shapes of the first sub-wing SFW1-2 and the second sub-wing SFW2-2 may be changed to be substantially parallel to the first and second light source substrates LSB1 and LSB2, respectively. The first sub-wing SFW1-2 may make contact with the upper surface of the first light source substrate LSB1 to fix the first light source substrate LSB1. The second sub-wing SFW2-2 may make contact with the upper surface of the second light source substrate LSB2 to fix the second light source substrate LSB2. The first and second sub-wings SFW1-2 and SFW2-2 may have a low rigidity. Thus, the first and second light source substrates LSB1 and LBS2 may not be damaged.

The column portions COL-2 of the fixing pin FP-2 may pass through the first holes H1-2 of the main portion MP-2 and second holes H2 of the bottom chassis BS. Since the protrusion portions PP-2 have elasticity, the protrusion portions PP-2 may pass through the first holes H1-2 and second holes H2. The protrusion portions PP-2 may be fixed to the lower surface of the bottom chassis BS. Consequently, the light source substrates LSB may be fixed to the bottom chassis BS by the fixing part FI-2.

The fixed light source substrates LSB1 and LSB2 may be separated from the bottom chassis BS by removing the fixing pin FP-2 from the bottom chassis BS and the main portion MP-2. In detail, in case that the fixing pin FP-2 may be removed, the groove HP may be restored to its original shape, and the force fixing the first and second light source substrates LSB1 and LSB2 may be released. Therefore, the first and second light source substrates LSB1 and LSB2 may be separated from the bottom chassis BS.

Consequently, the first and second light source substrates LSB1 and LSB2 may be easily disposed on and fixed to the bottom chassis BS by the fixing part FI-2, and may be separated from the bottom chassis BS.

FIG. 20 is a schematic plan view showing the fixing parts disposed between the light source substrates in the display device according to the fourth embodiment of the disclosure.

Referring to FIG. 20, the light source substrates LSB may be disposed in the first and second directions DR1 and DR2. The fixing parts FI-2 may be disposed between a K-th light source substrate LSB and a (K+1)th light source substrate LSB in the first direction. In other words, the fixing parts FI-2 may be disposed between long sides of the light source substrates LSB adjacent to each other. The fixing parts FI-2 may fix two light source substrates LSB adjacent to each other to the bottom chassis BS. Although not shown in figures, the fixing parts FI-2 may be disposed between short sides of the light source substrates LSB adjacent to each other.

Although the embodiments of the disclosure have been described, it is understood that the disclosure is not limited to these embodiments but various changes and modifications can be made by one ordinary skilled in the art within the spirit and scope of the disclosure as hereinafter claimed. Therefore, the disclosed subject matter is not limited to any single embodiment described herein, and the scope of the disclosure shall be determined according to the attached claims and their equivalents.

What is claimed is:

1. A display device comprising:
a display panel;
light source substrates disposed under the display panel;
light sources disposed on the light source substrates; and
a first fixing part disposed between the light source substrates, the first fixing part comprising:
a first main portion disposed between the light source substrates; and
first wings extending from an upper end of the first main portion to be substantially parallel to the light source substrates and disposed on the light source substrates.

2. The display device of claim 1, further comprising an optical part between the display panel and the light source substrates.

3. The display device of claim 2, wherein the light source substrates are disposed in a first direction and a second direction crossing the first direction.

4. The display device of claim 3, wherein the first fixing part is disposed between a k-th light source substrate and a (k+1)th light source substrate among the light source substrates disposed in the first direction.

5. The display device of claim 4, wherein the first wings comprise:
a first sub-wing extending in the first direction and disposed on the k-th light source substrate; and
a second sub-wing extending in the first direction and disposed on the (k+1)th light source substrate.

6. The display device of claim 3, further comprising a bottom chassis that accommodates the light source substrates, the light sources, and the optical part.

7. The display device of claim 6, wherein the first main portion comprises:
a first body vertically extending between the light source substrates; and
a supporter extending from a lower end of the first body to be substantially parallel to a bottom portion of the bottom chassis, wherein the supporter is disposed in a recess defined in the bottom portion of the bottom chassis.

8. The display device of claim 6, wherein the first fixing part further comprises a fixing pin that fixes the light source substrates to the bottom chassis.

9. The display device of claim 8, wherein the fixing pin comprises:
a horizontal portion extending in the second direction; and
a column portion extending downward from the horizontal portion, wherein
the horizontal portion is disposed on the first wings,
the column portion is inserted into a first hole defined in the first main portion, and
a lower end of the column portion is connected to the bottom chassis.

10. The display device of claim 9, wherein the column portion is inserted into a second hole defined in a bottom portion of the bottom chassis to overlap the first hole.

11. The display device of claim 9, wherein the lower end of the column portion has a hook shape and is disposed under the bottom chassis.

12. The display device of claim 6, further comprising a second fixing part disposed at an edge of the bottom chassis, wherein the second fixing part comprises:
a second main portion disposed between the edge of a bottom portion of the bottom chassis and a corresponding light source substrate among the light source substrates; and
a second wing extending from an upper end of the second main portion to be substantially parallel to the corresponding light source substrate and disposed on the corresponding light source substrate.

13. The display device of claim 3, wherein the first fixing part is disposed between a k-th light source substrate and a (k+1)th light source substrate among the light source substrates disposed in the second direction.

14. The display device of claim 1, wherein the light source substrates comprise a glass material.

15. The display device of claim 1, wherein the first wings are elastically deformable.

16. The display device of claim 1, wherein the first wings make contact with an upper portion of the light source substrates to fix the light source substrates.

17. A display device comprising:
a display panel;
light source substrates disposed under the display panel;
light sources disposed on the light source substrates;
an optical part disposed between the display panel and the light source substrates; and
a fixing part disposed between the light source substrates, the fixing part comprising:
a main portion disposed between a K-th light source substrate and a (K+1)th light source substrate;
a first wing extending from an upper end of the main portion to be substantially parallel to the K-th light source substrate;
a second wing extending from the upper end of the main portion to be substantially parallel to the (K+1)th light source substrate; and
a fixing pin disposed in a groove defined by the first wing and the second wing, wherein the first wing and the second wing are elastically deformable.

18. The display device of claim 17, further comprising a bottom chassis that accommodates the light source substrates, the light sources, and the optical part, wherein the fixing pin comprises a column portion inserted into a first hole defined in the main portion and a second hole defined in a bottom portion of the bottom chassis, and a lower end of the column portion is connected to the bottom chassis.

19. A display device comprising:
a display panel;
light source substrates disposed under the display panel;
light sources disposed on the light source substrates;
an optical part disposed between the display panel and the light source substrates; and
fixing parts disposed in one side of a corresponding light source substrate among the light source substrates, each of the fixing parts comprising:
a main portion disposed in the one side of the corresponding light source substrate; and
a wing extending from an upper end of the main portion to be substantially parallel to the corresponding light source substrate and disposed on the corresponding light source substrate, wherein the wing is elastically deformable.

20. The display device of claim 19, further comprising a bottom chassis that accommodates the light source substrates, the light sources, and the optical part, wherein
each of the fixing parts comprises a fixing pin to fix the light source substrates to the bottom chassis, and
the fixing pin comprises a column portion inserted into a first hole defined in the main portion and a second hole defined in a bottom portion of the bottom chassis.
